(19) United States
(12) Patent Application Publication
(10) Pub. No.: US 2025/0216361 A1
(43) Pub. Date: Jul. 3, 2025

(54) YOUNG'S MODULUS AND POISSON'S RATIO DETERMINATION IN OBJECTS OF ARBITRARY GEOMETRY SYSTEMS AND METHODS

(71) Applicant: METROLASER, INC., Laguna Hills, CA (US)

(72) Inventors: Andrei K. Dioumaev, Irvine, CA (US); James Davis Trolinger, Costa Mesa, CA (US)

(21) Appl. No.: 18/664,133

(22) Filed: May 14, 2024

Related U.S. Application Data
(63) Continuation-in-part of application No. 18/354,507, filed on Jul. 18, 2023, now abandoned.
Application No. 18/354,507 is a continuation of application No. 17/388,515, filed on Jul. 29, 2021, now abandoned.
(63) Continuation-in-part of application No. 17/388,515, filed on Jul. 29, 2021, now abandoned.
(60) Provisional application No. 63/058,360, filed on Jul. 29, 2020.

(51) Int. Cl. G01N 29/04; G06F 30/23; G06F 119/14

(52) U.S. Cl. CPC G01N 29/045; G06F 30/23; G01N 2291/02827; G06F 2119/14

(57) ABSTRACT

Described herein are systems and methods for Young's modulus and Poisson's ratio determination of an object of arbitrary geometry. A measured vibrational response spectrum of the object is collected, and a simulated vibrational response spectrum of the object is generated. The measured vibrational response spectrum is compared with the simulated vibrational response spectrum. The comparison is treated as a global nonlinear optimization problem. An objective function is proposed to enable comparison of two spectra, which are available on two incompatible frequency scales, and have different number of peaks. The actual values of the Young's modulus and the Poisson's ratio are identified as the best-fitting values that minimize a mismatch between the simulated vibrational response spectrum and the measured vibrational response spectrum. Suitable systems for performing the methods are also provided.

### CROSS-REFERENCE TO RELATED APPLICATIONS

This application is a continuation-in-part of U.S. application Ser. No. 18/354,507 filed Jul. 18, 2023 and U.S. application Ser. No. 17/388,515 filed Jul. 29, 2021, both of which claim the benefit of U.S. Provisional Application No. 63/058,360 filed Jul. 29, 2020 and entitled “A Method for Determining the Young Modulus and Poisson Ratio of the Material in Objects of any Geometry,” the disclosures of which are hereby incorporated by reference in their entirety for all purposes.

### STATEMENT REGARDING GOVERNMENT SUPPORT

The present disclosure is based upon work supported by the Defense Advanced Research Project Agency (DARPA) under Contract No. 140D6318C0085.

### TECHNICAL FIELD

The present invention relates generally to Young's modulus and Poisson's ratio determination and, more particularly, to methods and systems for determining the Young's Modulus and Poisson's ratio of the material in objects of any geometry.

### BACKGROUND

Methods employed for measurements of Young's modulus and Poisson's ratio often use vibrational resonance-response spectra and their comparison with theoretical predictions. Some methods, however, require various assumptions, such as assuming a known Poisson's ratio or Young's modulus. Some methods are also applicable exclusively to test samples of specific geometries and/or cannot be generalized to measurements on objects of arbitrary geometry. Some methods also do not address an underlying problem of comparing pairs of spectra with different numbers of peaks, despite requiring individual peaks assignments and the corresponding frequency scale re-scaling.

Therefore, there is a need in the art for systems and methods that address the above deficiencies, other deficiencies known in the industry, or at least offer an alternative to current techniques.

### BRIEF SUMMARY

Systems and methods are provided for Young's modulus and Poisson's ratio determination. According to one or more embodiments of the present disclosure, a method is provided. The method may include collecting a measured vibrational response spectrum of an object under defined experimental conditions, generating a simulated vibrational response spectrum of the object, and identifying values of the Young's modulus and Poisson's ratio that minimizes a mismatch between the simulated vibrational response spectrum and the measured vibrational response spectrum. Suitable systems for performing the method are also provided.

According to one or more embodiments of the present disclosure, a method of determining Young's modulus and Poisson's ratio of an object is provided. The method may include collecting a measured vibrational response spectrum of the object, comparing the measured vibrational response spectrum with a simulated vibrational response spectrum, and identifying a Young's modulus and a Poisson's ratio that minimize a mismatch between the simulated vibrational response spectrum and the measured vibrational response spectrum. Suitable systems for performing the method are also provided.

According to one or more embodiments of the present disclosure, a system is provided. The system may include a non-transitory memory storing instructions and one or more hardware processors configured to execute the instructions that causes the system to perform operations. The operations may include collecting a measured vibrational response spectrum of an object, generating a simulated vibrational response spectrum of the object, and minimizing a mismatch between the simulated vibrational response spectrum and the measured vibrational response spectrum by simultaneously optimizing both a Young's modulus and a Poisson's ratio using a global nonlinear optimization.

### BRIEF DESCRIPTION OF THE DRAWINGS

The description will be more fully understood with reference to the following figures in which components may not be drawn to scale, which are presented as various embodiments and should not be construed as a complete depiction of the scope of the present disclosure.

FIG. 1 illustrates, employing simulated data, the dependence of the resonant frequencies of a series of consecutive natural modes of an object, generated using a fixed Poisson's ratio but varying Young's modulus, in accordance with an embodiment of the disclosure.

FIG. 2 illustrates the same series of resonant frequencies of an object (i.e., the same modes of the same object as FIG. 1) for a fixed Young's modulus but varying Poisson's ratio, in accordance with an embodiment of the disclosure.

FIG. 3 illustrates residual mismatch of the simulated spectra from the measured one as a function of relative variation in the value of the Young's modulus used in simulations, in accordance with an embodiment of the disclosure.

FIG. 4 illustrates the decrease in standard deviation over all pairwise assigned peaks in the global optimization procedure as the optimal values of the Poisson's ratio is found by nonlinear minimization, in accordance with an embodiment of the disclosure.

FIG. 5A is a flowchart of a process of determining the Young's modulus and Poisson's ratio of the material in objects of any geometry, according to an embodiment of the present disclosure.

FIG. 5B is a flowchart of a process of determining the Young's modulus and Poisson's ratio of the material in objects of any geometry, according to an embodiment of the present disclosure.

FIG. 6 is a block diagram of a computer system suitable for implementing the process of FIG. 5A and/or the process of FIG. 5B, according to an embodiment of the present disclosure.

FIG. 7 is a block diagram of a system for implementing the process of FIG. 5A and/or the process of FIG. 5B, according to an embodiment of the present disclosure.

FIG. 8 is a block diagram of a system for implementing the process of FIG. 5A, the process of FIG. 5B, method S100 of FIG. 9, and method S200 of FIG. 10, in accordance with various embodiments.

FIG. 9 illustrates a flowchart for a method, in accordance with various embodiments.

FIG. 10 illustrates another flowchart for a method, in accordance with various embodiments.

Embodiments of the present invention and their advantages are best understood by referring to the detailed description that follows. It should be appreciated that like reference numerals are used to identify like elements illustrated in one or more of the figures.

### DETAILED DESCRIPTION

The present disclosure provides systems and methods of measuring material parameters, the Young's modulus (elasticity) and Poisson's ratio, of the material in an object. The systems and methods provided herein are applicable to objects of arbitrary geometry and do not rely on any a priori information other than the geometry of said object.

Embodiments of the present disclosure may be based on a fact that any solid object has a unique “vibrational” spectrum of natural vibrational frequencies that forms a unique signature for the object. The object's geometry defines the number of resonance peaks and their distribution in the vibrational spectrum, which depends on three material parameters, Young's modulus, density, and Poisson's ratio. The density is readily obtainable by weighing the object, and the volume can be determined from a CAD (Computer Aided Design) file that defines the object's geometry. Conventionally, the values of the Young's modulus and the Poisson's ratio are provided by measurements performed on specially designed test specimen, and correspondent protocols are hardly generalizable to parts of arbitrary geometry. Material parameters may vary among different objects, and the present disclosure may be useful especially in the field of Additive Manufacturing (AM), which involves manufacturing practices that can lead to widely varying material parameters between separately built objects.

Embodiments of the present disclosure may be based on cross-comparison of measured and theoretically predicted vibrational spectra, which can differ initially due to the peak positions in experimentally measured spectra being defined by the actual values of material parameters of the tested object, whereas the vibrational spectra in simulations are defined by initially assumed values of Young's modulus, density, and Poisson's ratio. The actual and assumed values can differ significantly, and the difference between the measured and simulated data may be used for evaluation the actual values from their comparison. Therefore, a method is based on comparison of the following:
1. Measured vibrational spectra provided by one of various methods, such as, but not limited to, by exciting the object with a piezo and measuring the spectra with a Laser Doppler Vibrometer (LDV); and
2. Predicted vibrational spectra derived by one of various methods, such as Finite Element Method (FEM) simulations.

The predicted and measured vibrational spectra can differ for various reasons. For example, whereas simulated vibrational spectra may include all possible resonance modes for an object, the measured vibrational spectra can lack resonance peaks that were not detected in an experiment or include extra peaks not caused by the object itself. Therefore, measured and predicted vibrational spectra can occur that contain a different number of resonance peaks. Further, since simulated spectra depend on potentially incorrectly assumed material parameters, their frequency scale may differ from reality. To address these and other issues, embodiments of the present disclosure may treat spectra comparison as an optimization problem and use correlation as the objective function in optimizing the comparison of the two vibrational spectra.

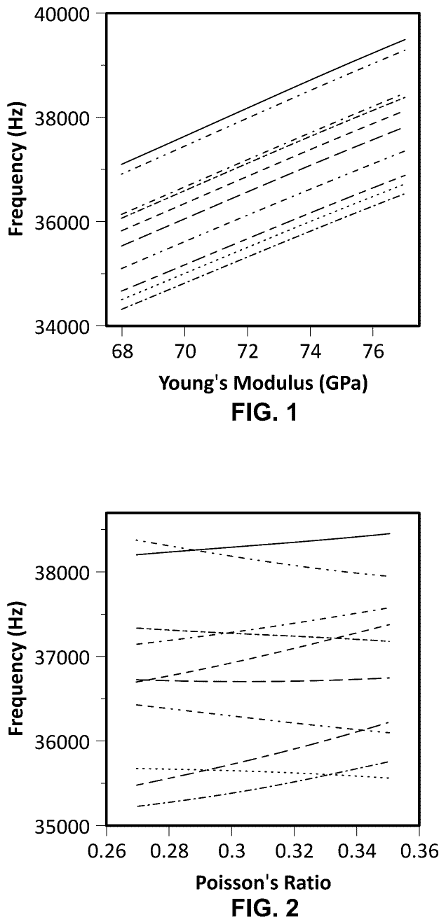

FIG. 1 illustrates the dependence of the resonant frequencies of a series of consecutive natural modes of an object when the Poisson's ratio is fixed but the Young's modulus is varied (each trace is a specific mode), in accordance with an embodiment of the disclosure. FIG. 2 illustrates the dependence of the same series of resonant frequencies of an object (the same object as FIG. 1) when the Young's modulus is fixed but the Poisson's ratio is varied, in accordance with an embodiment of the disclosure. The different traces represent a set of consecutive resonant modes, with the figures illustrating that the influence of the two material parameters are separable. The data in FIGS. 1 and 2 were obtained by FEM on an assumed object and are shown for illustrative purposes only.

Referring to FIG. 1, the predicted peaks' positions can be re-scaled by adjusting the value of Young's modulus used in the prediction. The main factor that defines the frequency scale is the Young's modulus. All resonance frequencies (f) of a given solid body depend on the square root of the Young's modulus, E, in a linear manner, f∝\sqrt{E}. Due to this quasi-linear scalability, the adjustment of Young's modulus in the predicted spectra is accomplished by linear stretching or contracting the vibrational spectra from a single simulated dataset. Any initial “guess” of material parameters creates a usable set of simulated data.

Referring to FIG. 2, unlike Young's modulus, the Poisson's ratio affects different vibration modes differently. However, as shown, the peak positions depend smoothly on Poisson's ratio and are readily approximated by, for example, a low-power polynomial, separately for each vibrational mode. Therefore, an optimization-based adjustment of the Poisson's ratio value requires data from several re-runs that create a series of simulated datasets with a fixed (although arbitrary) value of Young's modulus, but with varying values of Poisson's ratio.

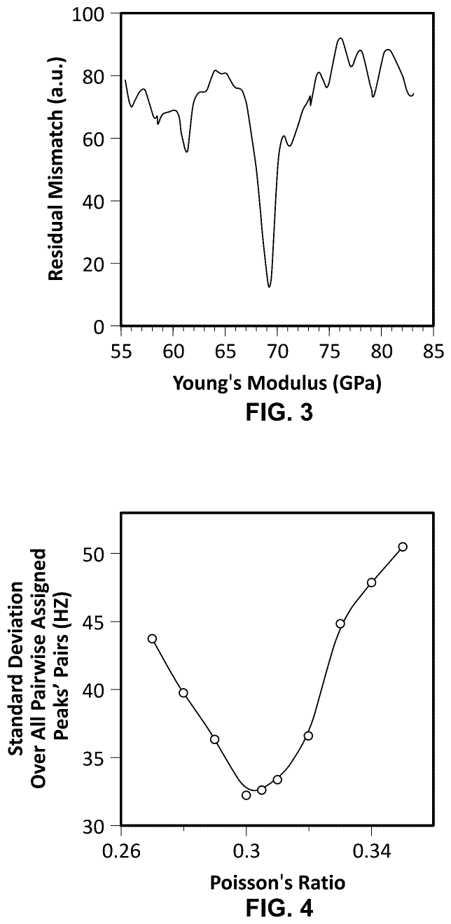

FIG. 3 illustrates residual mismatch between the peak positions in two spectra as a function of the Young's modulus, in accordance with an embodiment of the disclosure. FIG. 4 illustrates standard deviation over all pairwise-assigned peak's pairs in the two spectra as a function of Poisson's ratio, in accordance with an embodiment of the disclosure. Referring to FIGS. 3 and 4, the difference in the pattern of dependences of the frequencies of the individual resonant modes (see FIGS. 1, and 2) provides enough information for nonlinear optimization in the space of the two adjustable parameters, Young's modulus and Poisson's ratio. As shown, the search path may contain many local minima (see, e.g., FIG. 3), but a stochastic search engine, for example, “simulated annealing,” converges to a single minimum. On a broader level, FIGS. 3 and 4 illustrate, in part, the existence of the global minimum (FIGS. 3 and 4 present two cross-sections along the two coordinates of two adjustable parameters) obtained by nonlinear optimization of the objective function. The minima presented in FIGS. 3 and 4 illustrate the two cross-sections in the space of the objective function minimization, the global minimum, at which the best-fitting values of the Young's modulus and the Poisson's ratio, respectively, minimize the mismatch between the experimental and simulated resonance-response spectra. Therefore, these values reflect the actual values of the Young's modulus and the Poisson's ratio of the studied sample.

The success of this nonlinear optimization may be dependent on two factors: (i) availability of sufficient number of experimental peaks to correlate to, which is readily achieved by including the data from a wider frequency range covered in the experiment; and (ii) non-equidistant spacing between the individual peaks that creates a code-like pattern that could hardly be fitted with incorrect re-scaling; this non-equidistant spacing is automatic in parts with some degree of complexity.

Implementation of the present disclosure may include multiple strategies and algorithms. For example, implementation may include any combination of the following strategies:
1. A strategy to treat the comparison of experimental and simulated spectra as a global optimization procedure.
2. A strategy for selecting experimental conditions to provide sufficient experimental data. Experimental conditions may include, for example, fixed or “floating” objects, testing colinear or at an angle to excitation, object orientation, a choice of testing points, etc. For example, the object may be excited by touching a piezo-electric vibrator that provides excitation over the required frequency range, or other sources of excitation capable of providing a wide-range of frequencies, including but not limited to, external acoustic waves, hammers, etc. The experimental conditions may either minimize the objects coupling with the sample holder (e.g., a free-floating sample) or well-define the coupling (e.g., bolted).
3. A strategy for experimental spectra collection that yields a sufficient number of resonance peaks, although that number might both lack some of the natural modes but might include (artifact) resonances not coming from the object per se. Spectra can be collected, for example, by an appropriately positioned LDV that measures the vibration of the object at one or more points over the required frequency range. Wide frequency range that includes many natural modes provides extra information and increases the accuracy and robustness of the procedure
4. A strategy for generating simulated spectra, which do include all natural modes but might be on an unrealistic frequency scale due to inappropriate “initial estimate” on material parameters.

In addition to the above strategies, implementation may include any combination of the following algorithms:
1. An algorithm for comparing two spectra that differ in the number of peaks that are available on two inconsistent frequency scales. This algorithm may include, but is not limited to, the following steps:
   A. transforming an experimental spectrum into a table of peaks;
   B. comparing the table of FEM-generated natural modes' frequencies and the table of experimentally detected peaks;
   C. alternatively, instead of the previous two steps one might use frequency response spectra per se without converting them into the table of peaks; and
   D. creating an objective function for optimization; for instance, but not limited to, based on a correlation coefficient, an integral over the correlation function between the two spectra that is normalized in such a way that it adds a given quantity, e.g. an extra “1”, to the correlation coefficient upon an ideal overlap of any given pair of peaks, and less than that if the overlap is only partial;
   E. wherein the so defined correlation coefficient will be equal to the number of experimentally detected peaks if an ideally overlapping counterpart among the simulated peaks were to be found for each of the former upon proper readjustment of the frequency scale, and less than that number if the experimental spectrum involves artefact peaks that do not have counterparts among the simulated natural modes;
2. An algorithm to minimize the mismatch between the two spectra by optimizing globally both the Young's modulus and the Poisson's ratio. This algorithm may include, but is not limited to, the following:
   A. Treating the comparison of experimental and simulated spectra as a global nonlinear optimization problem
   B. A stochastic search engine to solve the global optimization to escape from local minima that are inevitable in this type of task. For instance, simulated annealing, but the potential choice is not restricted to this implementation, and any robust stochastic search, for instance, adaptive random search would work. The choice of specific search engine is not crucial, if it is sufficiently robust, as most stochastic search could be.
   C. The correlation coefficient described above, or an alternative mismatch-sensitive function, is used as the objective function to minimize the mismatch in overlap between the two spectra by nonlinear least squares optimization.
3. An algorithm to discriminate between the experimental peaks that do and do not originate from the object per se. This algorithm may include, but is not limited to, the following:
   A. A threshold is defined, at a particular level of overlap, that subdivides the peaks into two sub-populations. A “well-correlated” peak with an overlap above that threshold signals an extra pairwise assigned pair and may be considered to be coming from the object per se, while those with an overlap smaller than the threshold, may be suspected to originate from artifacts.
   B. The number of “well-correlated” peak-pairs increase in the course of optimization until only artifact peaks not coming from the sample per se are left unassigned to any natural mode of the studied object
   C. An additional linear regression on the sub-population of “well-correlated/pairwise-assigned” peak-pairs that yields also a specific pattern of residuals form this regression. The scatter of those residuals, for instance as measured by, but not limited to, the standard deviation among their sub-population, is employed as the ultimate criterium of goodness of fit (see, e.g., FIG. 4).
      The peaks tentatively assigned to “suspected artifacts” may be double-checked by comparing their experimentally recorded geometry, for instance by using a scanning laser Doppler vibrometer, to that of the theoretically predicted modes.

Embodiments of the present disclosure enable determining Young's modulus and Poisson's ratio:
1. for practically any solid body and any geometry, whose vibrational resonances can be excited in a range that is measurable by the employed method;
2. by employing a CAD file and an “initial guess” of the values of material parameters;
3. for objects created by techniques that might yield variations between separately produced objects and batches, such as AM;
4. with self-consistent results (e.g., the CAD file of the studied object is the only “input” requirement; all the rest is obtained within the procedure itself);
5. of solids that might be suspected to perform non-linearly under sufficient loads (e.g., the present disclosure may restrict the employed mechanical displacements to below a value of approximately one micron, i.e., to far less than the elongations required for measurements in conventional tensile tests);
6. with an accuracy of better than 1%, which is at least on par with conventional mechanical tests; or
7. any combination of the above.

Embodiments of the present disclosure do not require any specific restrictions that would limit its application to specially created “test” objects. For example, any “finished” object can be measured, and its own specific Young's modulus and Poisson's ratio can be determined. Additionally, embodiments of the present disclosure do not require any assumptions beyond that of “general linearity” if superposition principle holds, which is usually guaranteed under the employed conditions of minimalistic displacements under the vibrational excitation.

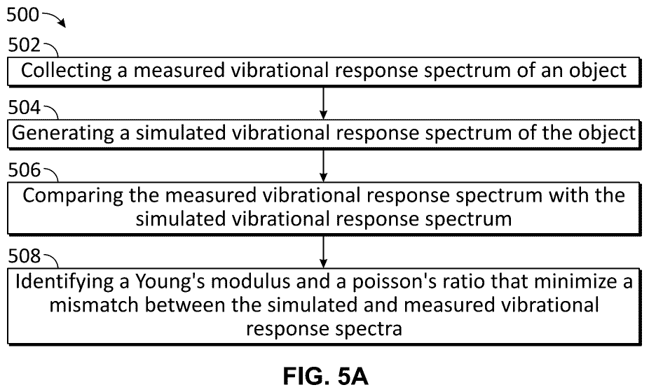

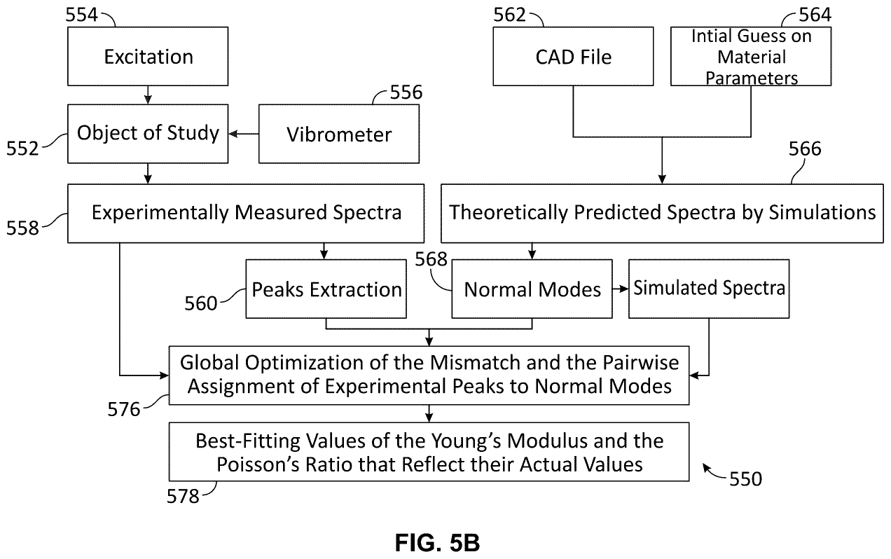

FIG. 5A is a flowchart of a process 500 of determining the Young's modulus and Poisson's ratio of the material in objects of any geometry, according to an embodiment of the present disclosure. It should be appreciated that any step, sub-step, sub-process, or block of process 500 may be performed in an order or arrangement different from the embodiments illustrated by FIG. 5A. For example, in other embodiments, one or more blocks may be omitted from or added to the process 500.

In block 502, process 500 may include collecting a measured vibrational response spectrum of an object. The experimental conditions of the collection process may be defined or varied. For example, the object may be fixed or floated, tested colinearly or at an angle to excitation, oriented as desired, etc. In addition, the method of excitation may be determined (e.g., via a piezo-electric vibrator that provides excitation over the required frequency range, etc.) and the experimental conditions may be selected to provide a sufficient number of resonance peaks. The response spectrum can be collected in many configurations, such as by an appropriately positioned LDV that measures the vibration of the object at one or more points over the required frequency range.

In block 504, process 500 may include generating a simulated vibrational response spectrum of the object. For instance, block 504 may include utilizing simulation by finite element method of the object's vibrations, using a CAD file of the object. The simulations may utilize an “initial guess” of the values of material parameters, which may be arbitrary, and does not have to be close to reality.

In block 506, process 500 may include comparing the measured vibrational response spectrum with the simulated vibrational response spectrum. As the objective function for nonlinear optimization, a correlation coefficient may be employed. For example, an integral over the correlation function between the two spectra may be normalized in such a way that it adds a given quantity (e.g., an extra “1”) to the correlation coefficient upon an ideal overlap of any given pair of peaks, and less than the given quantity if the overlap is only partial. In embodiments, the measured spectrum may be transformed into a table of peaks (e.g., a table of experimentally detected peaks), and this table may be compared to a table of frequencies of the natural modes predicted by simulations. Alternatively, the frequency response spectra may be used per se without converting them into tables of peaks. In some embodiments, block 506 may include discriminating between resonance peaks that do and do not originate from the object per se. For instance, a threshold may be defined that identifies or discriminates “well-correlated” peaks and those that originate from artifacts.

In block 508, process 500 includes identifying a Young's modulus and a Poisson's ratio that minimize a mismatch between the simulated and measured vibrational response spectra. For example, a mismatch between the simulated and measured vibrational response spectra may be minimized by optimizing both Young's modulus and Poisson's ratio. In embodiments, a global, simultaneous nonlinear optimization in the space of both Young's modulus and Poisson's ratio may identify the global minimum in the objective function. A stochastic search engine is recommended, although other configurations are contemplated.

FIG. 5B is a flowchart of a process 550 of determining the Young's modulus and Poisson's ratio of the material in objects of any geometry, according to an embodiment of the present disclosure. It should be appreciated that any step, sub-step, sub-process, or block of process 550 may be performed in an order or arrangement different from the embodiments illustrated by FIG. 5B. For example, in other embodiments, one or more blocks may be omitted from or added to the process 550.

As shown, an object of study 552 (i.e., an object of arbitrary geometry) may be excited, such as via a piezo-electric vibrator, an acoustic source or any other suitable excitation device (block 554). In block 556, the vibrational response of the object 552 may be collected, such as by an LDV that measure the vibration of the object 552 at one or more points over the required frequency range. In block 558, the experimentally measured spectra of the object 552 may be collected. In block 560, one or more peaks of the experimentally measured spectra may be extracted.

With continued reference to FIG. 5B, a CAD file 562 and an initial guess on material parameters 564 may be provided to generate a simulated vibrational response of the object 552. For example, in block 566, theoretically predicted spectra of the object 552 may be generated by simulations. In block 568, all normal modes for required frequency range of the theoretically predicted spectra may be identified or determined.

In block 576, process 550 includes global optimization of the mismatch and the pairwise assignment of experimental peaks to normal modes, such as described above. For example, the experimentally measured spectra, simulated spectra, extracted peaks, and normal modes may be utilized in the global optimization. In block 578, process 550 includes best-fitting values of the Young's modulus and the Poisson's ratio that reflect their actual values, such as described above. A simultaneous nonlinear optimization in the space of both Young's modulus and Poisson's ratio may identify the global minimum in the mismatch between the two spectra, reflecting the actual values of both Young's modulus and Poisson's ratio.

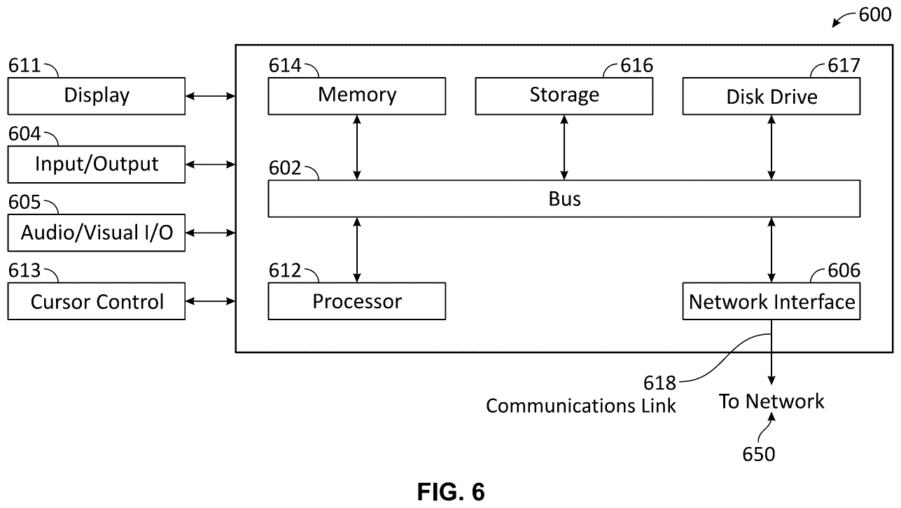

FIG. 6 is a block diagram of a computer system 600 suitable for implementing the process of FIG. 5A and/or the process of FIG. 5B, according to an embodiment of the present disclosure, according to an embodiment of the present disclosure. In various embodiments, the computing device 600 may comprise a personal computing device (e.g., smart phone, a computing tablet, a personal computer, laptop, etc.) or a network computing device (e.g., a network server), both of which are capable of communicating with a network 650.

Computer system 600 includes a bus 602 or other communication mechanism for communicating data, signals, and information between various components of computer system 600. Components include an input/output (I/O) component 604 that processes a user action, such as selecting keys from a keypad/keyboard and/or selecting one or more buttons, images, or links, such as for inputting or accessing/requesting data, and sends a corresponding signal to bus 602. I/O component 604 may also include an output component, such as a display 611 and a cursor control 613 (such as a keyboard, keypad, mouse, etc.). An optional audio/visual input/output (I/O) component 605 may also be included to allow a user to use voice for inputting information by converting audio signals and/or input or record images/videos by capturing visual data. Audio/visual I/O component 605 may allow the user to hear audio and view images/video. A transceiver or network interface 606 transmits and receives signals between computer system 600 and other devices, such as another communication device, service device, or a service provider server via network 650. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

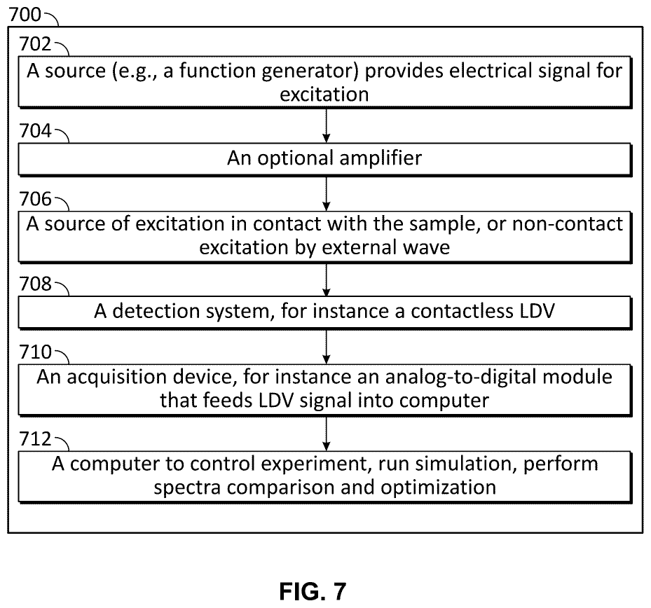

FIG. 7 is a block diagram of a system 700 for implementing the process of FIG. 5A and of FIG. 5B, according to an embodiment of the present disclosure. As shown, system 700 may include a source 702 (e.g., a function generator) that provides an electrical signal for excitation. In some embodiments, system 700 may include an amplifier 704 configured to amplify the electrical signal for excitation. System 700 includes an excitation source 706 and a detection system 708. The excitation source 706 may be any source of excitation in contact with the sample, or any non-contact excitation by external wave. The detection system 708 may be an LDV, such as a contactless LDV, or any other suitable detection device. In embodiments, system 700 may include an acquisition device 710. The acquisition device 710 may be an analog-to-digital module that feeds the detection system signal into a computer. As shown, system 700 may include a computer or any other logic device 712, such as the computer system 600 of FIG. 6, described above. The computer 712 may be configured to control the methods described herein (e.g., control spectra acquisition, run simulation, perform spectra comparison and nonlinear optimization).

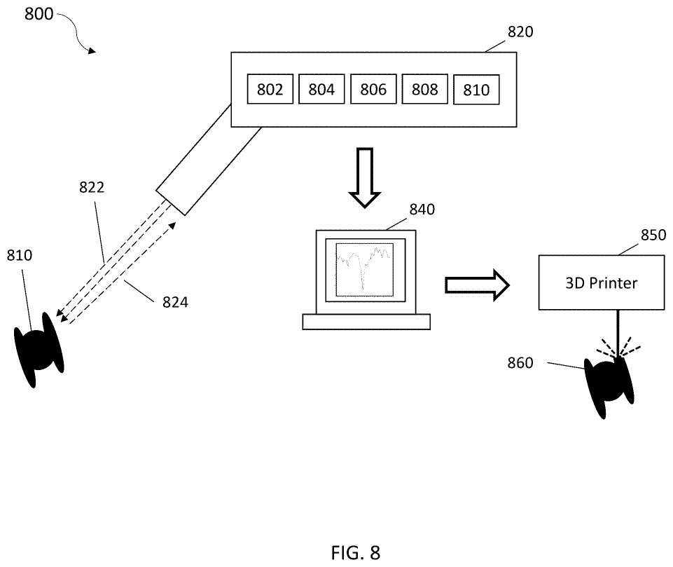

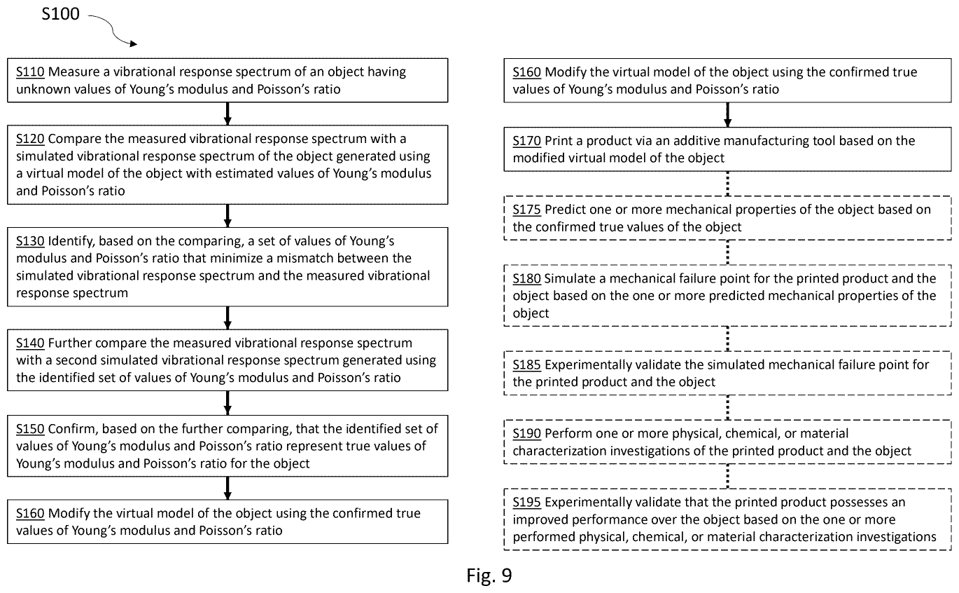

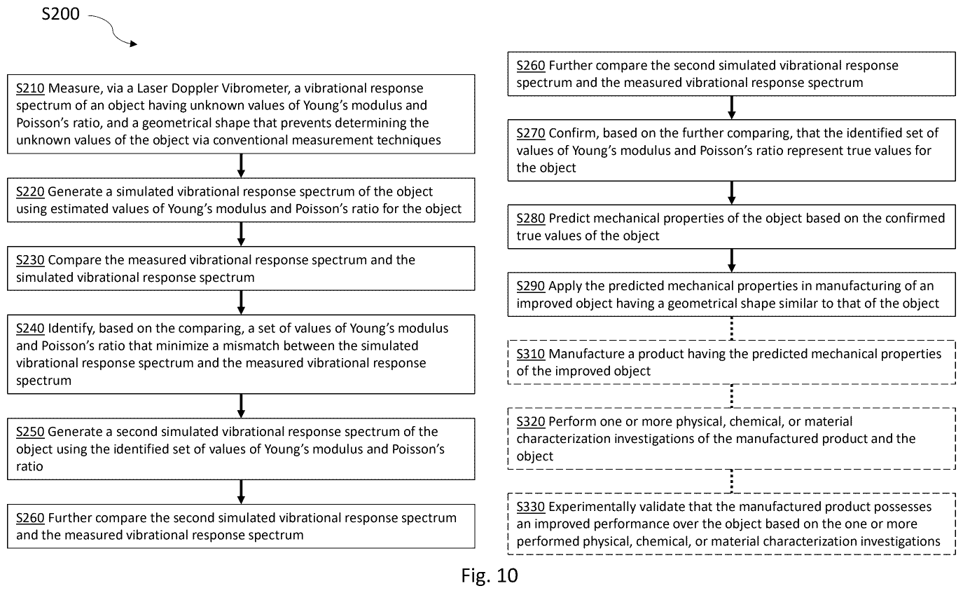

FIG. 8 is a block diagram of a system 800 for implementing the process of FIG. 5A, the process of FIG. 5B, method S100 of FIG. 9, and method S200 of FIG. 10, in accordance with various embodiments. As illustrated in FIG. 8, system 800 includes an acoustic sensing system 820 and a computer system 840 configured to acquire data from the acoustic sensing system 820. In one or more embodiments, the acoustic sensing system 810 may include a Laser Doppler Vibrometer (LDV) configured to acquire a vibrational response spectrum of an object 810 at one or more points on the object. As illustrated in FIG. 8, the LDV/acoustic sensing system 810 sends out a laser beam 822 to probe the object 810 and receives the reflected laser beam 824. The LDV/acoustic sensing system 810 then acquire the vibrational response spectrum of the object 810 from the received signal, in accordance with one or more embodiments.

In one or more embodiments, the acoustic sensing system 810 may include a source 802, such as source 702 (e.g., a function generator) that can provide electrical signal for excitation, an amplifier 804, such as the amplifier 704, configured to amplify the electrical signal for excitation, an excitation source 806, such as excitation source 706, a detection system 808, such as detection system 708, and/or an acquisition device 810, such as acquisition device 710, which may include an analog-to-digital module configured for acquiring data and transferring it to the computer system 840, such as computers system 712, or the computer system 600 of FIG. 6, described above. The computer 840 may be configured to control the methods described herein (e.g., control spectra acquisition, run simulation, perform spectra comparison and nonlinear optimization).

As further illustrated in FIG. 8, the system 800 includes the acoustic sensing system 820 that is configured to acquire the vibrational response spectrum of an object 810, which may have unknown values of Young's modulus and Poisson's ratio. The object 810 may have a geometrical shape that prevents determining the unknown values, for example, of Young's modulus and Poisson's ratio, of the object via conventional measurement techniques. As also illustrated in FIG. 8, the system 800 includes an additive manufacturing tool 850 configured to print a three-dimensional (3D) product 860. In one or more embodiments, the additive manufacturing tool 850 is coupled to and controlled by the computer system 840, which may include one or more hardware processors and a non-transitory computer readable medium operably coupled thereto. In some embodiments, the one or more hardware processors/the computer system 840 may be operationally coupled to the acoustic sensing system 820 for acquisition of the vibrational response spectrum. One or more operations that can be performed by the one or more hardware processors/the computer system 840 and the additive manufacturing tool 850, may include one or more of the following: generating a simulated vibrational response spectrum of the object 810 using a virtual model of the object 810 with estimated values of Young's modulus and Poisson's ratio, comparing the measured vibrational response spectrum with the simulated vibrational response spectrum of the object 810 generated using a virtual model of the object with estimated values of Young's modulus and Poisson's ratio, and/or identifying, based on the comparing, a set of values of Young's modulus and Poisson's ratio that minimize a mismatch between the simulated vibrational response spectrum and the measured vibrational response spectrum. In one or more embodiments, comparing the measured vibrational response spectrum with the simulated vibrational response spectrum may further include comparing peak positions of a plurality of simulated peaks in the simulated vibrational response spectrum to one or more peak positions of a plurality of measured peaks in the measured vibrational response spectrum; based on comparing the peak positions, re-scaling peak positions of at least a portion of the plurality of simulated peaks to match peak positions of corresponding measured peaks of the plurality of measured peaks; and/or discriminating between one or more measured peaks from the plurality of measured peaks that do and do not originate from the object. In one or more embodiments, the matched peak positions, for example, the re-scaled peak positions of the at least a portion of the plurality of simulated peaks and the corresponding measured peaks of the plurality of measured peaks, can be used in the identifying of the set of values of Young's modulus and Poisson's ratio that minimize the mismatch.

The following operations that may be performed by the one or more hardware processors/the computer system 840 and the additive manufacturing tool 850, can include further comparing the measured vibrational response spectrum with a second simulated vibrational response spectrum generated using the identified set of values of Young's modulus and Poisson's ratio; confirming, based on the further comparing, that the identified set of values of Young's modulus and Poisson's ratio represent true values of Young's modulus and Poisson's ratio for the object 810; modifying the virtual model of the object using the confirmed true values of Young's modulus and Poisson's ratio; and printing the 3D product 860 via the additive manufacturing tool 850 based on the modified virtual model of the object 810.

Additional operations that can be performed by the one or more hardware processors/the computer system 840 and the additive manufacturing tool 850, may include predicting one or more mechanical properties of the object based on the confirmed true values of the object, and simulating a mechanical failure point for the printed product and the object based on the one or more predicted mechanical properties of the object, where the simulated mechanical failure point for the printed product and the object are experimentally validated. In one or more embodiments, the simulated mechanical failure point includes a yield strength of the printed product and the object, or a design error of the printed product or the object.

In one or more embodiments, modifying the virtual model of the object 810 may include altering at least one of a physical dimension or a material composition in the virtual model of the object 810. In one or more embodiments, the virtual model of the object 810 may include a three-dimensional (3D) rendering and the modified virtual model of the object comprises a modified 3D rendering having at least one of an altered physical dimension or an altered material composition in the virtual model of the object 810.

In one or more embodiments, the system 800 can be used for accurate modeling of objects or parts produced by another additive manufacturing tool. In one or more embodiments, the system 800 can be used for performing failure analysis of any additively manufactured parts or objects, characterizing the printing process of an additive manufacturing too, and/or comparing objects/parts produced in different machines and with different printing parameters. In one or more embodiments, the object 810 and/or the 3D product 860 may include a metal or a metal alloy having two or more metals. In one or more embodiments, the vibrational response spectrum of the object 810 and/or the 3D product 860 include any acoustic/vibrational frequency ranges of metal/alloys.

In one or more embodiments, the object 810 and/or the 3D product 860 may be analyzed to assess failure. In one or more embodiments, the object 810 and/or the 3D product 860 may be investigated to determine a failure due to a high load that would induce a high stress that could be past the yield point of the material of the object 810 and/or the 3D product 860.

It is known that Young's modulus and Poisson's ratio can be found in handbooks for pure materials and alloys. However, it is also well known that Young's Modulus and Poisson's ratio for objects and materials produced by additive manufacturing are not the same as that of the pure materials and alloys, thus, they are usually estimated or measured. The Young's modulus and Poisson's ratio for objects and material produced by an additive manufacturing process depend on many factors including printing parameters such as printing speed, laser power, laser spot size, air flow, and even position on the printing bed. They vary between different machines and different printing runs. Otherwise, identical parts printed in the same printing run do not have precisely the same material parameters.

When an object experiences a large number of repetitive loads, this failure mode is also often analyzed using related techniques since repetitively loaded parts can fail at loads lower than those that would cause yielding. This can be performed using SN, strain life and crack growth models using similar computer models. Failure models are also used for objects that might fail due to buckling, e.g., long, thin objects loaded in the thin direction, impact, e.g., objects involved in car crash, projectile impact etc., and creep, e.g., objects in a high temperate environment. These can also be analyzed using similar but more complicated numerical techniques. In all of these cases, accurate modeling and failure predictions require accurate values for the Young's modulus.

In one or more embodiments, the system 800 can be used for determining that an object has failed using a Laser Doppler Vibrometer to find the mechanical failure point. In one or more embodiments, upon performing adjustments using simulated data as described above with respect to FIG. 8, and then printing a 3D product using the modified virtual model of the object that will no longer fail at the mechanical failure point of the object 810 by increasing a yield strength of the object.

FIG. 9 illustrates a flowchart for method S100, in accordance with various embodiments. In one or more embodiments, method S100 may be processed using system 700 described with respect to FIG. 7 or system 800 described with respect to FIG. 8. As illustrated in FIG. 9, the method $100 includes, at step S110, measuring a vibrational response spectrum of an object having unknown values of Young's modulus and Poisson's ratio; at step S120, comparing the measured vibrational response spectrum with a simulated vibrational response spectrum of the object generated using a virtual model of the object with estimated values of Young's modulus and Poisson's ratio; at step S130, identifying, based on the comparing, a set of values of Young's modulus and Poisson's ratio that minimize a mismatch between the simulated vibrational response spectrum and the measured vibrational response spectrum; at step S140, further comparing the measured vibrational response spectrum with a second simulated vibrational response spectrum generated using the identified set of values of Young's modulus and Poisson's ratio; at step S150, confirming, based on the further comparing, that the identified set of values of Young's modulus and Poisson's ratio represent true values of Young's modulus and Poisson's ratio for the object; at step S160, modifying the virtual model of the object using the confirmed true values of Young's modulus and Poisson's ratio; and at step S170, printing a product via an additive manufacturing tool based on the modified virtual model of the object.

In one or more embodiments, modifying the virtual model of the object may include altering at least one of a physical dimension or a material composition in the virtual model of the object. In one or more embodiments, the virtual model of the object may include a three-dimensional (3D) rendering and the modified virtual model of the object may include a modified 3D rendering having at least one of an altered physical dimension or an altered material composition in the virtual model of the object.

In various embodiments, the method S100 may further optionally include, at step S175, predicting one or more mechanical properties of the object based on the confirmed true values of the object; optionally at step S180, simulating a mechanical failure point for the printed product and the object based on the one or more predicted mechanical properties of the object; and optionally at step S185, experimentally validating the simulated mechanical failure point for the printed product and the object. In one or more embodiments, the simulated mechanical failure point may include a yield strength of the printed product and the object, or a design error of the printed product or the object.

In various embodiments, the method S100 may further optionally include, at step S190, performing one or more physical, chemical, or material characterization investigations of the printed product and the object; and optionally at step S195, experimentally validating that the printed product possesses an improved performance over the object based on the one or more performed physical, chemical, or material characterization investigations.

In one or more embodiments, the vibrational response spectrum of the object is measured using a Laser Doppler Vibrometer configured to acquire the vibrational response spectrum of the object at one or more points on the object. In one or more embodiments, comparing the measured vibrational response spectrum with the simulated vibrational response spectrum may include comparing peak positions of a plurality of simulated peaks in the simulated vibrational response spectrum to one or more peak positions of a plurality of measured peaks in the measured vibrational response spectrum; and based on comparing the peak positions, re-scaling peak positions of at least a portion of the plurality of simulated peaks to match peak positions of corresponding measured peaks of the plurality of measured peaks. In one or more embodiments, the matched peak positions, 1) the re-scaled peak positions of the at least a portion of the plurality of simulated peaks and 2) the corresponding measured peaks of the plurality of measured peaks, are used in the identifying of the set of values of Young's modulus and Poisson's ratio that minimize the mismatch.

FIG. 10 illustrates a flowchart for method S200, in accordance with various embodiments. In one or more embodiments, method S200 may be processed using system 700 described with respect to FIG. 7 or system 800 described with respect to FIG. 8. As illustrated in FIG. 10, the method S200 includes, at step S210, measuring, via a Laser Doppler Vibrometer, a vibrational response spectrum of an object having unknown values of Young's modulus and Poisson's ratio, and a geometrical shape that prevents determining the unknown values of the object via conventional measurement techniques; at step S220, generating a simulated vibrational response spectrum of the object using estimated values of Young's modulus and Poisson's ratio for the object; at step S230, comparing the measured vibrational response spectrum and the simulated vibrational response spectrum; at step S240, identifying, based on the comparing, a set of values of Young's modulus and Poisson's ratio that minimize a mismatch between the simulated vibrational response spectrum and the measured vibrational response spectrum; at step S250, generating a second simulated vibrational response spectrum of the object using the identified set of values of Young's modulus and Poisson's ratio; at step S260, further comparing the second simulated vibrational response spectrum and the measured vibrational response spectrum; at step S270, confirming, based on the further comparing, that the identified set of values of Young's modulus and Poisson's ratio represent true values for the object; at step S280, predicting mechanical properties of the object based on the confirmed true values of the object; and at step S290, applying the predicted mechanical properties in manufacturing of an improved object having a geometrical shape similar to that of the object.

In various embodiments, the method S200 may further optionally include, at step S310, manufacturing a product having the predicted mechanical properties of the improved object. In one or more embodiments, the manufactured product and the object comprise at least two metals and are different in at least a physical dimension or a material composition.

In various embodiments, the method S200 may further optionally include, at step S320, performing one or more physical, chemical, or material characterization investigations of the manufactured product and the object; and optionally at step S330, experimentally validating that the manufactured product possesses an improved performance over the object based on the one or more performed physical, chemical, or material characterization investigations.

In one or more embodiments, comparing the measured vibrational response spectrum with the simulated vibrational response spectrum may include comparing peak positions of a plurality of simulated peaks in the simulated vibrational response spectrum to one or more peak positions of a plurality of measured peaks in the measured vibrational response spectrum; based on comparing the peak positions, re-scaling peak positions of at least a portion of the plurality of simulated peaks to match peak positions of corresponding measured peaks of the plurality of measured peaks; and/or discriminating between one or more measured peaks from the plurality of measured peaks that do and do not originate from the object. In one or more embodiments, the matched peak positions, 1) the re-scaled peak positions of the at least a portion of the plurality of simulated peaks and 2) the corresponding measured peaks of the plurality of measured peaks, are used in the identifying of the set of values of Young's modulus and Poisson's ratio that minimize the mismatch.

Additional features are set forth in part in the description that follows and will become apparent to those skilled in the art upon examination of the specification and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

Embodiments described above illustrate, but do not limit, the invention. It should also be understood that numerous modifications and variations are possible in accordance with the principles of the present invention. Accordingly, the scope of the invention is defined only by the following claims.

What is claimed:

1. A method comprising:
measuring a vibrational response spectrum of an object having unknown values of Young's modulus and Poisson's ratio;
comparing the measured vibrational response spectrum with a simulated vibrational response spectrum of the object generated using a virtual model of the object with estimated values of Young's modulus and Poisson's ratio;
identifying, based on the comparing, a set of values of Young's modulus and Poisson's ratio that minimize a mismatch between the simulated vibrational response spectrum and the measured vibrational response spectrum;
further comparing the measured vibrational response spectrum with a second simulated vibrational response spectrum generated using the identified set of values of Young's modulus and Poisson's ratio;
confirming, based on the further comparing, that the identified set of values of Young's modulus and Poisson's ratio represent true values of Young's modulus and Poisson's ratio for the object;
modifying the virtual model of the object using the confirmed true values of Young's modulus and Poisson's ratio; and
printing a product via an additive manufacturing tool based on the modified virtual model of the object.

2. The method of claim 1, wherein modifying the virtual model of the object comprises altering at least one of a physical dimension or a material composition in the virtual model of the object.

3. The method of claim 2, wherein the virtual model of the object comprises a three-dimensional (3D) rendering and the modified virtual model of the object comprises a modified 3D rendering having at least one of an altered physical dimension or an altered material composition in the virtual model of the object.

4. The method of claim 3, further comprising:
predicting one or more mechanical properties of the object based on the confirmed true values of the object;
simulating a mechanical failure point for the printed product and the object based on the one or more predicted mechanical properties of the object; and
experimentally validating the simulated mechanical failure point for the printed product and the object.

5. The method of claim 4, wherein the simulated mechanical failure point includes a yield strength of the printed product and the object, or a design error of the printed product or the object.

6. The method of claim 1, further comprising:
performing one or more physical, chemical, or material characterization investigations of the printed product and the object; and
experimentally validating that the printed product possesses an improved performance over the object based on the one or more performed physical, chemical, or material characterization investigations.

7. The method of claim 1, wherein the vibrational response spectrum of the object is measured using a Laser Doppler Vibrometer configured to acquire the vibrational response spectrum of the object at one or more points on the object.

8. The method of claim 1, wherein comparing the measured vibrational response spectrum with the simulated vibrational response spectrum comprises:
comparing peak positions of a plurality of simulated peaks in the simulated vibrational response spectrum to one or more peak positions of a plurality of measured peaks in the measured vibrational response spectrum; and
based on comparing the peak positions, re-scaling peak positions of at least a portion of the plurality of simulated peaks to match peak positions of corresponding measured peaks of the plurality of measured peaks,
wherein the matched peak positions, 1) the re-scaled peak positions of the at least a portion of the plurality of simulated peaks and 2) the corresponding measured peaks of the plurality of measured peaks, are used in the identifying of the set of values of Young's modulus and Poisson's ratio that minimize the mismatch.

9. A system comprising:
an acoustic sensing system configured to acquire a vibrational response spectrum of an object having unknown values of Young's modulus and Poisson's ratio;
an additive manufacturing tool configured to print a three-dimensional (3D) product; and
one or more hardware processors and a non-transitory computer readable medium operably coupled thereto, the one or more hardware processors operationally coupled to the acoustic sensing system for acquisition of the vibrational response spectrum, the one or more hardware processors operationally coupled to, and configured to control, the additive manufacturing tool, wherein the non-transitory computer readable medium comprising a plurality of instructions stored in association therewith that are accessible to, and executable by, the one or more processors, to perform one or more operations, which comprise:
generating a simulated vibrational response spectrum of the object using a virtual model of the object with estimated values of Young's modulus and Poisson's ratio;
comparing the measured vibrational response spectrum with the simulated vibrational response spectrum of the object generated using a virtual model of the object with estimated values of Young's modulus and Poisson's ratio;
identifying, based on the comparing, a set of values of Young's modulus and Poisson's ratio that minimize a mismatch between the simulated vibrational response spectrum and the measured vibrational response spectrum;
further comparing the measured vibrational response spectrum with a second simulated vibrational response spectrum generated using the identified set of values of Young's modulus and Poisson's ratio;
confirming, based on the further comparing, that the identified set of values of Young's modulus and Poisson's ratio represent true values of Young's modulus and Poisson's ratio for the object;
modifying the virtual model of the object using the confirmed true values of Young's modulus and Poisson's ratio; and
printing the 3D product via the additive manufacturing tool based on the modified virtual model of the object.

10. The system of claim 9, wherein the acoustic sensing system comprises a Laser Doppler Vibrometer (LDV) configured to acquire the vibrational response spectrum of the object at one or more points on the object.

11. The system of claim 9, wherein modifying the virtual model of the object comprises altering at least one of a physical dimension or a material composition in the virtual model of the object.

12. The system of claim 11, wherein the virtual model of the object comprises a three-dimensional (3D) rendering and the modified virtual model of the object comprises a modified 3D rendering having at least one of an altered physical dimension or an altered material composition in the virtual model of the object.

13. The system of claim 12, wherein the one or more operations further comprise:
predicting one or more mechanical properties of the object based on the confirmed true values of the object, and
simulating a mechanical failure point for the printed product and the object based on the one or more predicted mechanical properties of the object,
wherein the simulated mechanical failure point for the printed product and the object are experimentally validated.

14. The system of claim 13, wherein the simulated mechanical failure point includes a yield strength of the printed product and the object, or a design error of the printed product or the object.

15. The system of claim 9, wherein comparing the measured vibrational response spectrum with the simulated vibrational response spectrum comprises:
comparing peak positions of a plurality of simulated peaks in the simulated vibrational response spectrum to one or more peak positions of a plurality of measured peaks in the measured vibrational response spectrum;
based on comparing the peak positions, re-scaling peak positions of at least a portion of the plurality of simulated peaks to match peak positions of corresponding measured peaks of the plurality of measured peaks; and
discriminating between one or more measured peaks from the plurality of measured peaks that do and do not originate from the object,
wherein the matched peak positions, 1) the re-scaled peak positions of the at least a portion of the plurality of simulated peaks and 2) the corresponding measured peaks of the plurality of measured peaks, are used in the identifying of the set of values of Young's modulus and Poisson's ratio that minimize the mismatch.

16. A method comprising:
measuring, via a Laser Doppler Vibrometer, a vibrational response spectrum of an object having unknown values of Young's modulus and Poisson's ratio, and a geometrical shape that prevents determining the unknown values of the object via conventional measurement techniques;
generating a simulated vibrational response spectrum of the object using estimated values of Young's modulus and Poisson's ratio for the object;
comparing the measured vibrational response spectrum and the simulated vibrational response spectrum;
identifying, based on the comparing, a set of values of Young's modulus and Poisson's ratio that minimize a mismatch between the simulated vibrational response spectrum and the measured vibrational response spectrum;
generating a second simulated vibrational response spectrum of the object using the identified set of values of Young's modulus and Poisson's ratio;
further comparing the second simulated vibrational response spectrum and the measured vibrational response spectrum;
confirming, based on the further comparing, that the identified set of values of Young's modulus and Poisson's ratio represent true values for the object;
predicting mechanical properties of the object based on the confirmed true values of the object; and
applying the predicted mechanical properties in manufacturing of an improved object having a geometrical shape similar to that of the object.

17. The method of claim 16, further comprising:
manufacturing a product having the predicted mechanical properties of the improved object.

18. The method of claim 17, wherein the manufactured product and the object comprise at least two metals and are different in at least a physical dimension or a material composition.

19. The method of claim 16, further comprising:
performing one or more physical, chemical, or material characterization investigations of the manufactured product and the object; and
experimentally validating that the manufactured product possesses an improved performance over the object based on the one or more performed physical, chemical, or material characterization investigations.

20. The method of claim 16, wherein comparing the measured vibrational response spectrum with the simulated vibrational response spectrum comprises:
comparing peak positions of a plurality of simulated peaks in the simulated vibrational response spectrum to one or more peak positions of a plurality of measured peaks in the measured vibrational response spectrum;
based on comparing the peak positions, re-scaling peak positions of at least a portion of the plurality of simulated peaks to match peak positions of corresponding measured peaks of the plurality of measured peaks; and
discriminating between one or more measured peaks from the plurality of measured peaks that do and do not originate from the object,
wherein the matched peak positions, 1) the re-scaled peak positions of the at least a portion of the plurality of simulated peaks and 2) the corresponding measured peaks of the plurality of measured peaks, are used in the identifying of the set of values of Young's modulus and Poisson's ratio that minimize the mismatch.
